(19) United States
(12) Patent Application Publication
(10) Pub. No.: US 2024/0356683 A1
(43) Pub. Date: Oct. 24, 2024

(54) RLC BUFFER REDUCTION BASED ON NETWORK CODING AND OUTER CODE

(71) Applicant: QUALCOMM Incorporated, San Diego, CA (US)

(72) Inventors: Ruiming ZHENG, Beijing (CN); Kangqi LIU, San Diego, CA (US); Xipeng ZHU, San Diego, CA (US); Aziz GHOLMIEH, Del Mar, CA (US); Changlong XU, Beijing (CN)

(21) Appl. No.: 18/571,195

(22) PCT Filed: Aug. 31, 2021
(86) PCT No.: PCT/CN2021/115514

§ 371 Date: Dec. 15, 2023

(51) Int. Cl. H04L 1/1867; H04L 1/00; H04L 1/1607; H04W 28/06

(52) U.S. Cl. CPC H04L 1/1887; H04L 1/0063; H04L 1/1671; H04L 1/1874; H04W 28/065

(57) ABSTRACT

This disclosure provides systems, devices, apparatus, and methods, including computer programs encoded on storage media, for RLC buffer reduction techniques. A wireless transmitter may generate at least one RLC PDU and at least one RLC parity PDU based on an encoding procedure for an RLC SDU. The wireless transmitter may store, in an RLC buffer, the at least one RLC parity PDU for the RLC SDU and transmit, to a MAC layer, at least one of the segmentation of the RLC SDU or the at least one RLC PDU. A wireless receiver may generate RLC PDU feedback for at least one of the RLC SDU, the segmentation of the RLC SDU, or the at least one RLC PDU and transmit, to an RLC layer, the RLC PDU feedback including an indication of an additional number of encoded RLC PDUs and at least one of an ACK_SN or a NACK_SN.

### TECHNICAL FIELD

The present disclosure relates generally to communication systems, and more particularly, to techniques for reducing a radio link control (RLC) buffer.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communication (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may generate at least one radio link control (RLC) protocol data unit (PDU) and at least one RLC parity PDU based on an encoding procedure for an RLC service data unit (SDU); store, in an RLC buffer, the at least one RLC parity PDU for the RLC SDU based on a segmentation of the RLC SDU; and transmit, to a medium access control (MAC) layer, at least one of the segmentation of the RLC SDU or the at least one RLC PDU.

In another aspect of the disclosure, a method, a computer-readable medium, and an apparatus are provided. The apparatus may generate RLC PDU feedback for at least one of an RLC SDU, a segmentation of the RLC SDU, or at least one RLC PDU associated with the RLC SDU; and transmit, to an RLC layer, the RLC PDU feedback including an indication of an additional number of encoded RLC PDUs for assembling the RLC SDU and at least one of an acknowledgment (ACK) sequence number (SN) (ACK_SN) or a negative acknowledgment (NACK) SN (NACK_SN) associated with the at least one of the RLC SDU, the segmentation of the RLC SDU, or the at least one RLC PDU.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a call flow diagram illustrating communications between a transmit (Tx) device and a receive (Rx) device.

FIG. 5 illustrates a diagram of a radio link control (RLC) entity.

FIG. 6 illustrates diagrams for initial transmission procedures of a packet.

FIG. 7 is a flowchart for a retransmission procedure of a packet.

FIG. 8 is a diagram for a retransmission procedure of a packet.

FIG. 9 is a flowchart for a procedure of a receiver device.

FIG. 10 is a diagram of a network coding/outer code procedure for an RLC entity.

FIG. 11 is a flowchart of a method of wireless communication at a wireless transmitter.

FIG. 12 is a flowchart of a method of wireless communication at a wireless transmitter.

FIG. 13 is a flowchart of a method of wireless communication at a wireless receiver.

FIG. 14 is a flowchart of a method of wireless communication at a wireless receiver.

FIG. 15 is a diagram illustrating an example of a hardware implementation for an example apparatus.

FIG. 16 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Aspects described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described aspects may occur. Implementations may range a spectrum from chip-level or modular components to non-modular, non-chip-level implementations and further to aggregate, distributed, or original equipment manufacturer (OEM) devices or systems incorporating one or more aspects of the described aspects. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that aspects described herein may be practiced in a wide variety of devices, chip-level components, systems, distributed arrangements, aggregated or disaggregated components, end-user devices, etc. of varying sizes, shapes, and constitution.

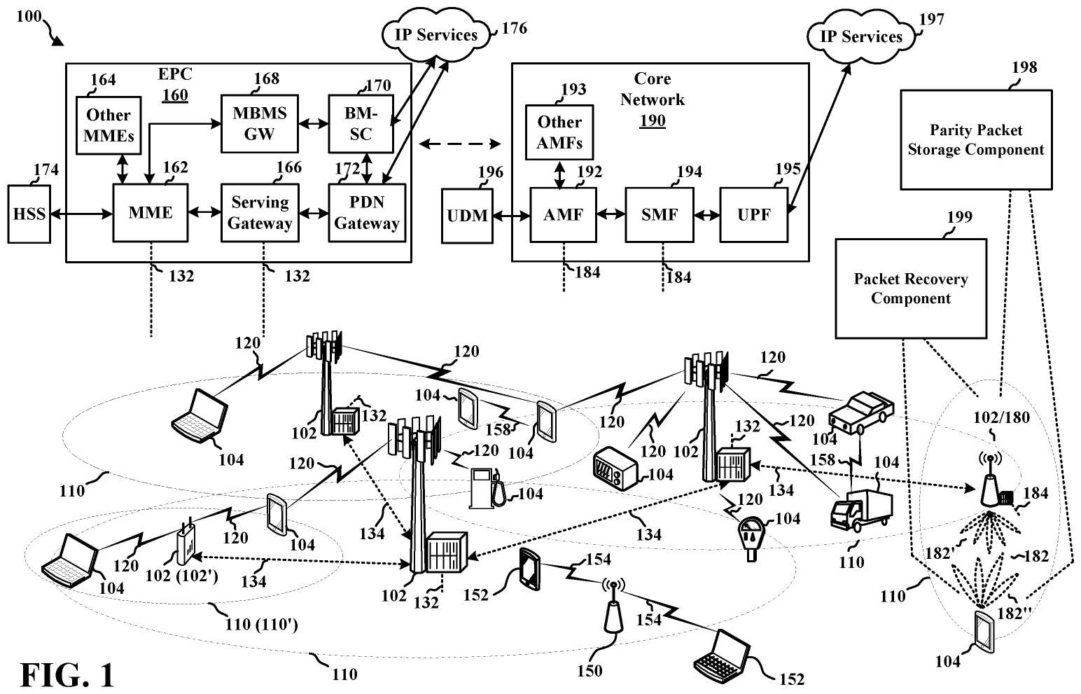

FIG. 1 is a diagram illustrating an example of a wireless communications system and an access network 100. The wireless communications system (also referred to as a wireless wide area network (WWAN)) includes base stations 102, user equipments (UEs) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 and/or the base station 180 may include a parity packet storage component 198 configured to generate at least one radio link control (RLC) protocol data unit (PDU) and at least one RLC parity PDU based on an encoding procedure for an RLC service data unit (SDU); store, in an RLC buffer, the at least one RLC parity PDU for the RLC SDU based on a segmentation of the RLC SDU; and transmit, to a medium access control (MAC) layer, at least one of the segmentation of the RLC SDU or the at least one RLC PDU. In certain aspects, the UE 104 and/or the base station 180 may include a packet recovery component 199 configured to generate RLC PDU feedback for at least one of an RLC SDU, a segmentation of the RLC SDU, or at least one RLC PDU associated with the RLC SDU; and transmit, to an RLC layer, the RLC PDU feedback including an indication of an additional number of encoded RLC PDUs for assembling the RLC SDU and at least one of an acknowledgment (ACK) sequence number (SN) (ACK_SN) or a negative acknowledgment (NACK) SN (NACK_SN) associated with the at least one of the RLC SDU, the segmentation of the RLC SDU, or the at least one RLC PDU. Although the following description may be focused on 5G NR, the concepts described herein may be applicable to other similar areas, such as LTE, LTE-A, CDMA, GSM, and other wireless technologies.

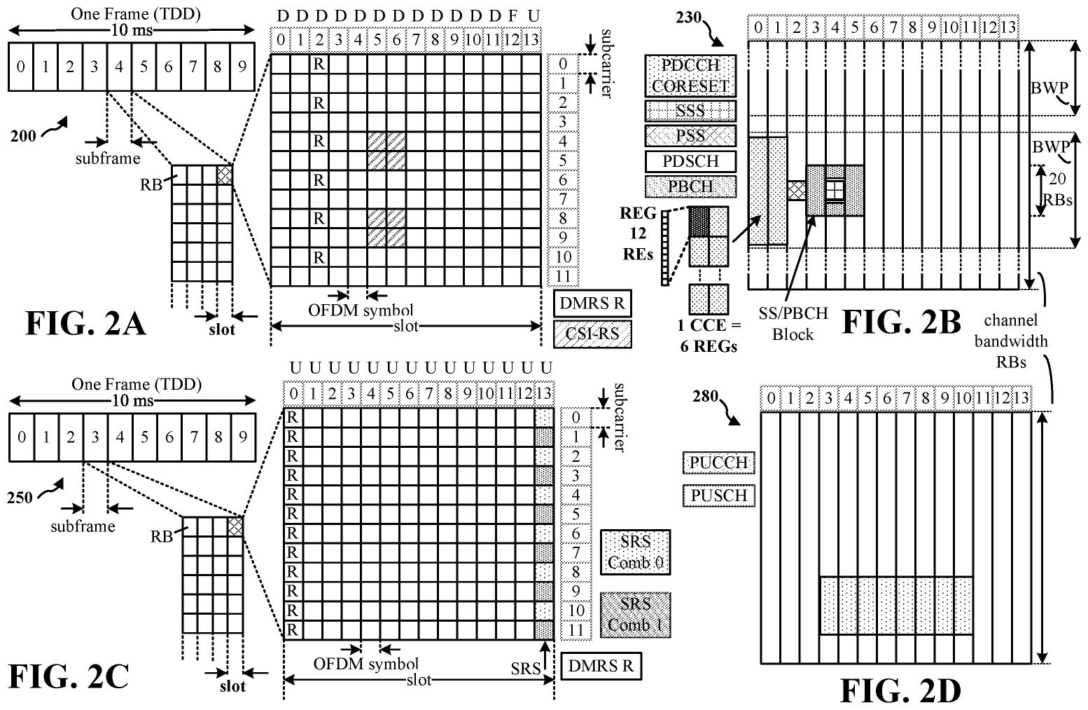

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or NACK). The PUSCH carries data, and may additionally be used to carry a buffer status report (BSR), a power headroom report (PHR), and/or UCI.

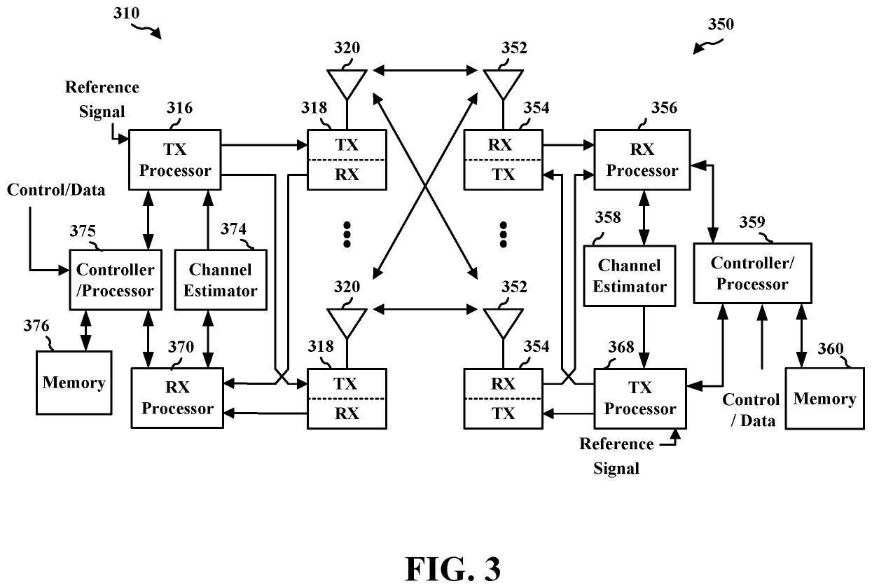

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, an RLC layer, and a MAC layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through an automatic repeat request (ARQ), concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the parity packet storage component 198 of FIG. 1.

At least one of the TX processor 316, the RX processor 370, and the controller/processor 375 may be configured to perform aspects in connection with the packet recovery component 199 of FIG. 1.

Wireless communication systems may be configured to share available system resources and provide various telecommunication services (e.g., telephony, video, data, messaging, broadcasts, etc.) based on multiple-access technologies such as CDMA systems, TDMA systems, FDMA systems, OFDMA systems, SC-FDMA systems, TD-SCDMA systems, etc., that support communication with multiple users. In many cases, common protocols that facilitate communications with wireless devices are adopted in various telecommunication standards. For example, communication methods associated with enhanced mobile broadband (eMBB), mMTC, and ultra-reliable low latency communication (URLLC) may be incorporated in the 5G NR telecommunication standard, while other aspects may be incorporated in the 4G LTE standard. As mobile broadband technologies are part of a continuous evolution, further improvements in mobile broadband remain useful to continue the progression of such technologies.

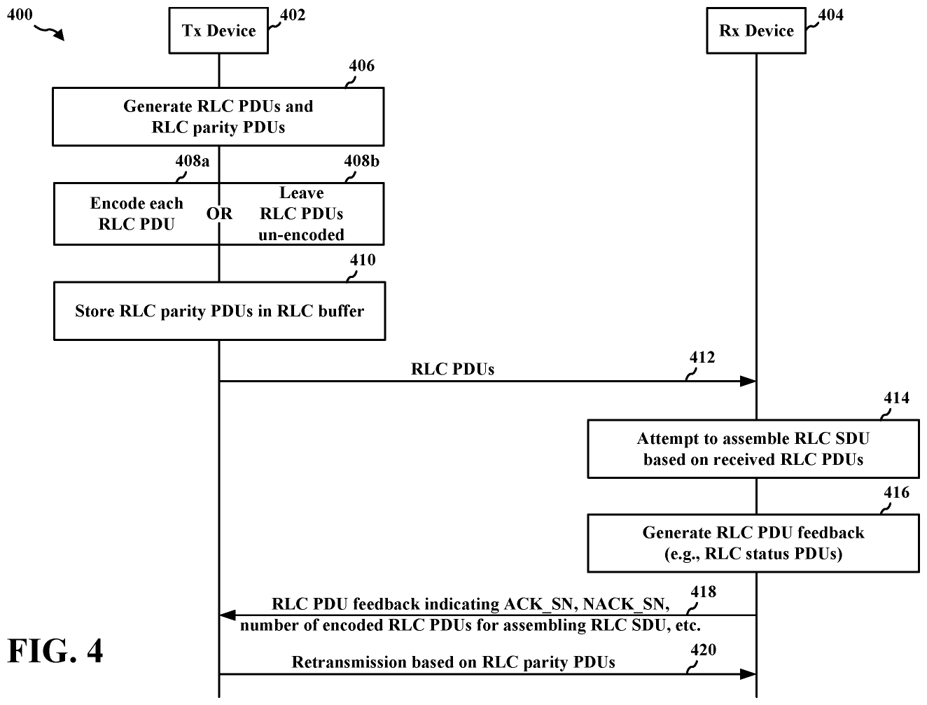

FIG. 4 is a call flow diagram 400 illustrating communications between a Tx device 402 and an Rx device 404. In examples, the Tx device 402 and the Rx device 404 may be associated with an RLC entity. At 406, the Tx device 402 may generate RLC PDUs and RLC parity PDUs based on an RLC SDU received from an upper layer. For example, a Tx side of an RLC entity may receive an RLC SDU from a PDCP layer to generate the RLC PDUs and the RLC parity PDUs based on a coding function.

At 408a, the Tx device 402 may encode each RLC PDU generated, at 406. Alternatively, the Tx device 402 may segment the RLC SDU into un-coded RLC PDUs and leave, at 408b, the RLC PDUs un-coded for transmission to the Rx device 404. For either procedure performed, at 408a or 408b, the Tx device may store, at 410, the RLC parity PDUs in an RLC buffer. The RLC parity PDUs may be used for retransmissions of a missing packet at the Rx device 404, rather than transmitting the encoded/un-coded RLC PDUs to the Rx device 404 on a separate retransmission.

At 412, the Tx device 402 may perform an initial transmission of the RLC PDUs to the Rx device 404. The Rx device 404 may attempt, at 414, to assemble the RLC SDU based on the RLC PDUs received, at 412. In examples, the Rx device 404 may not receive, at 412, all of the RLC PDUs generated, at 406, by the Tx device 402 for assembling the RLC SDU. Thus, at 416, the Rx device 404 may generate RLC PDU feedback indicative of ACK/NACK information for the generated RLC PDUs. The RLC PDU feedback may be configured as an RLC status PDU.

At 418, the Rx device 404 may transmit the RLC PDU feedback (e.g., RLC status PDU) to the Tx device 402. The RLC PDU feedback may indicate ACK_SN information, NACK_SN information, a number of encoded RLC PDUs still to be received by the Rx device 404 for assembling the RLC SDU, etc. At 420, the Tx device 402 may perform a retransmission to the Rx device 404, where the retransmission includes the RLC parity PDUs stored, at 410, in the RLC buffer. The Rx device 404 may use the RLC parity PDUs received, at 420, from the Tx device 402 to assemble/reassemble the RLC SDU.

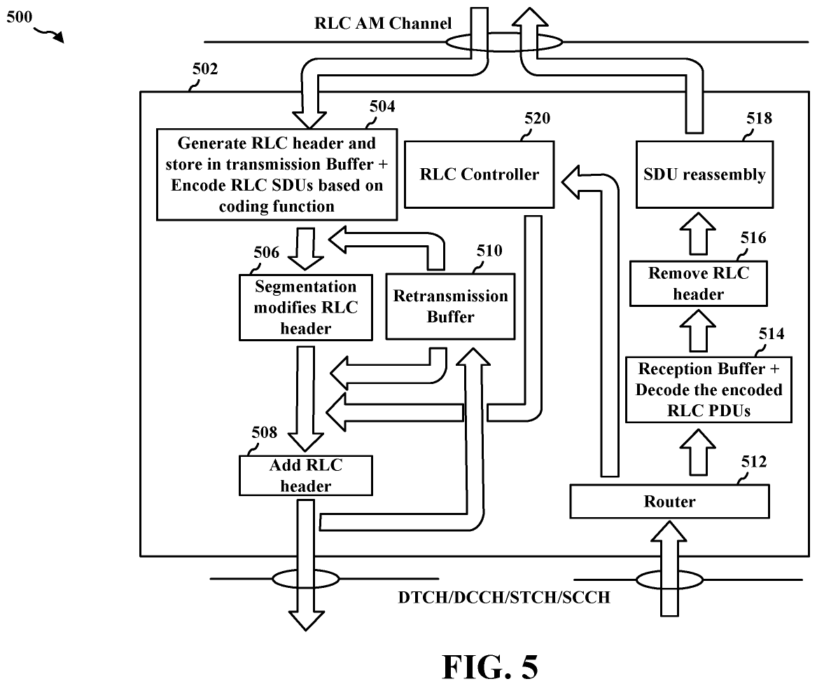

FIG. 5 illustrates a diagram 500 of an RLC entity 502. Network coding and/or outer coding for the RLC entity 502 may be used to increase a reliability of the RLC entity 502. For example, fountain codes may be used to recover a transmitted packet at a receiver if a number of received packets is larger than a source packet, such as an RLC SDU. Fountain codes may be rateless codes, such that a coded packet may be recovered regardless of the packet that is received or not received at the receiver. Luby transform (LT) code and Raptor code are examples of fountain codes. Raptor code may be considered an enhanced fountain code, where the Raptor code may correspond to a low-density parity-check (LDPC) code plus a weak LT code.

Fountain codes may also be referred to as network codes, as fountain codes may be executed at a network layer. In an example, Raptor code may be executed for MBMS procedures in the application layer, as opposed to being executed for Layer 2 procedures. Layer 2 may include the PDCP layer, the RLC layer, and the MAC layer. Network coding techniques used to increase the reliability of a network entity may be performed, e.g., in the RLC layer and/or the PDCP layer. Network coding/outer code may be used for procedures associated with multicast/broadcast services (MBS), vehicle-to-everything (V2X), integrated access and backhaul (IAB), PDCP duplication replacement, etc.

RLC procedures may be based on an acknowledgment mode (AM) or an unacknowledgment mode (UM) of the RLC entity 502. The RLC procedures performed in the AM may increase the reliability of the RLC layer. For example, the AM for the RLC layer may provide Layer 2 packet error correction via ARQ. The ARQ for the AM of the RLC layer may be associated with the RLC SDU or RLC SDU segmentation retransmission based on an RLC status PDU. In examples, the RLC status PDU may correspond to RLC PDU feedback from the receiver. A request/pulling procedure may be used to trigger reception of the RLC SDU at the transmitter based on receiving the RLC status PDU at the transmitter. The transmitter may retransmit one or more missing packets to the receiver based on the RLC status PDU. The RLC status PDU may be transmitted to the transmitter if a receiver entity detects a missing RLC SDU or a missing RLC SDU segmentation.

The UM for the RLC layer may be associated with decreased Layer 2 reliability. Rather than utilizing RLC PDU feedback, the UM may be based on a sliding window for packets of the RLC entity 502 at both the transmitter and the receiver of the RLC entity 502. Thus, segmentation/re-segmentation of the RLC SDU at the transmitter of the RLC entity 502 and reassembly of the segmented RLC SDU at the receiver entity may be less reliable in the UM without explicit RLC PDU feedback. That is, in contrast to the UM, the AM may utilize the ARQ procedure to provide explicit feedback for transmitted packets that increases the Layer 2 reliability.

In network coding, redundant information included in a coded packet may increase the reliability of packet transmissions based on error correction techniques for the missing packet. For example, a coding function for redundancy/parity packets may be used for recovering missing packets. Network coding/outer code may be implemented via Layer 2 protocols, for example, in the PDCP layer, the RLC layer, or a sublayer between the PDCP layer and the RLC layer. The network coding/outer code may be implemented by the transmitter entity and the receiver entity of the PDCP layer and the RLC layer.

The RLC entity 502 may be configured as an RLC AM entity. For example, the RLC entity 502 may receive a packet, such as an RLC SDU, from an upper layer (e.g., the PDCP layer) via an RLC AM channel. The RLC entity 502 may generate, at 504, an RLC header for the packet at a Tx side of the RLC entity 502 and store, 504, the RLC header in a transmission buffer, which may also be referred to as an RLC buffer. In aspects, the RLC entity 502 may additionally encode, at 504, the received packet (e.g., the RLC SDU) based on a coding function. Segmentation may be applied, at 506, to the RLC SDU based on an uplink grant from a lower layer (e.g., MAC layer), which may modify the RLC header. An updated RLC header may be added, at 508, to the segmentation(s) of the packet and transmitted to the lower layer (e.g., the MAC layer) via a dedicated traffic channel (DTCH), a dedicated control channel (DCCH), a shared traffic channel (STCH), or a shared control channel (SCCH). The updated RLC header may also be transmitted to a retransmission buffer 510 for packet retransmission, which may be re-segmented, at 506, and/or re-updated, at 508, prior to being transmitted to the lower layer.

At the Rx side of the RLC entity 502, a router 512 may generate and deliver RLC status PDUs, which may also be referred to as RLC PDU feedback, from the MAC layer via the DTCH, the DCCH, the STCH, or the SCCH. In a first aspect, the RLC status PDUs may be stored, at 514, in a reception buffer from which encoded RLC PDUs may be decoded. The RLC header may be removed, at 516, from the decoded RLC PDUs to reassemble, at 518, the RLC SDU, if packet segmentation was performed. If the RLC SDU was not segmented, the RLC header may be removed, at 516, and the packet may be transmitted directly to the PDCP layer without performing an SDU reassembly procedure, at 518. The RLC SDU/reassembled RLC SDU may be transmitted from the RLC layer to the PDCP layer via the RLC AM channel. In a second aspect, the router 512 may provide the RLC status PDU to the an RLC controller 520 on the Tx side of the RLC entity 502 for retransmission of an encoded packet. The RLC status PDU may report which packets correspond to ACKs and which packets correspond to NACKs. Packets that correspond to NACKs may be retransmitted to the MAC layer (e.g., based on the retransmission buffer 510, the segmentation, at 506, and/or updating the RLC header, at 508).

Outer code for the RLC layer may be used to reduce a buffer for high-speed traffic, such as for eMBB procedures. However, an imbalance between incoming high-speed packets and low data rate fluctuation from lower layers, particularly near a cell edge, may be associated with large buffers for Layer 2. For instance, unacknowledged RLC SDUs may be stored in the retransmission buffer 510 at the Tx side of the RLC entity 502 until an update is received from an RLC status PDU. The RLC status PDU may include ACK_SNs and NACK_SNs that update the packets stored in the Tx buffer/queue. RLC SDUs associated with an ACK may be discarded from the retransmission buffer 510. However, if network coding/outer code is configured for the RLC entity 502, the RLC SDUs may not have to be stored in the retransmission buffer 510, which may reduce a size of the retransmission buffer 510.

In aspects, the RLC entity 502 may transmit encoded RLC PDUs to lower layers (e.g., an initial packet transmission to the MAC layer) and store, at 504, parity packets for the RLC PDUs in the RLC buffer. The parity packets may be used for retransmissions of the RLC PDUs based on RLC PDU feedback/RLC status PDUs, which may include the ACK/NACK information. In some cases, retransmissions may be based on requesting source packets (e.g., the RLC SDU) from the upper layer (e.g., the PDCP layer), which may be associated with one entity (e.g., a UE modem) or multiple entities (e.g., a centralized unit (CU) and a distributed unite (DU)).

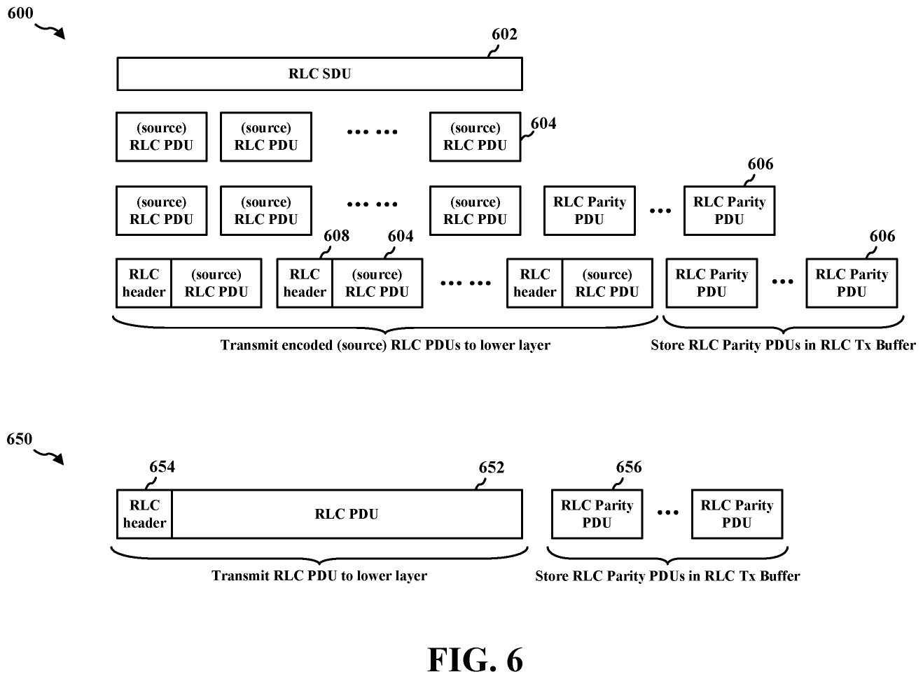

FIG. 6 illustrates diagrams 600-650 for initial transmission procedures of a packet. The RLC transmission buffer may store one or more parity packets for one or more (source) RLC PDUs 604/652. The one or more parity packets may be generated from a source packet, such as the RLC SDU 602 based on a per RLC SDU encoding procedure. RLC parity PDUs 606/656 may be stored in the RLC transmission buffer based on the network coding without storing the (source) RLC PDUs 604/652 in the RLC transmission buffer, which may reduce a size of the RLC transmission buffer. The RLC entity may subsequently use the RLC parity PDUs 606/656 to perform one or more packet retransmissions.

In a first aspect, an RLC entity may transmit encoded source RLC PDUs 604, while storing the RLC parity PDUs 606 for each RLC SDU 602 in the RLC transmission buffer. The RLC layer may receive an RLC SDU 602 from the PDCP layer. The RLC SDU 602 may be segmented into un-coded source RLC PDUs 604 based on a coding function. In some examples, a number of un-coded source RLC PDUs 604 may be configured by the PDCP layer. A coding function in the RLC layer may be used to encode the source RLC PDUs 604 and generate the RLC parity PDUs 606 based on the source RLC PDUs 604. The RLC parity PDUs 606 may be redundant packets used for retransmission procedures. A coding rate may also be configured by the PDCP layer, so that the number of RLC parity PDUs 606 may be controlled via signaling from the upper layer/PDCP layer.

Encoded packets transmitted to the lower layer may include the encoded source RLC PDUs 604 (e.g., associated with segments of the RLC SDU 602) and RLC headers 608. An RLC header 608 may be added to each encoded source RLC PDU 604 prior to transmission of the source RLC PDUs 604 to the lower layer/MAC layer. The source RLC PDUs 604 may correspond to a payload and the RLC headers 608 may correspond to additional information associated with the packet. While the RLC parity PDUs 606 may be stored in the RLC transmission buffer, the source RLC PDUs 604 may not be stored in the RLC transmission buffer after transmission of the encoded source RLC PDUs 604 to the lower layer.

In a second aspect, the packet may be transmitted to the lower layer/MAC layer as a single/combined RLC PDU 652 having a single RLC header 654. That is, rather than appending a plurality of RLC headers 608 to a plurality of source RLC PDUs 604, a single RLC header 654 may be appended to the single/combined RLC PDU 652 to reduce a transmission overhead. The coding function may be similarly executed in association with the single/combined RLC PDU 652 to generate one or more RLC parity PDUs 656, where the one or more RLC parity PDUs 656 may be stored in the RLC transmission buffer for performing retransmission procedures. The RLC entity may transmit the single/combined RLC PDU 652 or an RLC SDU segmentation to the lower layer and store the RLC parity PDUs 656 for each RLC SDU in the RLC transmission buffer without storing the single/combined RLC PDU 652 or the RLC SDU segmentation in the RLC transmission buffer.

In cases where the transmitted (source) RLC PDUs 604/652 corresponds to a complete RLC SDU 602, the RLC parity PDUs 606/656 associated with the RLC SDU 602 may not be stored in the RLC transmission buffer. The RLC header 654 may be appended to the single/combined RLC PDU 652 and subsequently transmitted to the lower layer (e.g., MAC layer) or the RLC headers 608 may be appended to each of the source RLC PDUs 604 for transmission to the lower layer. The single/combined RLC PDU 652 and the source RLC PDUs 604 (e.g., associated with the RLC SDU segmentations) may not be stored in the RLC transmission buffer after transmission of the packet to the lower layer.

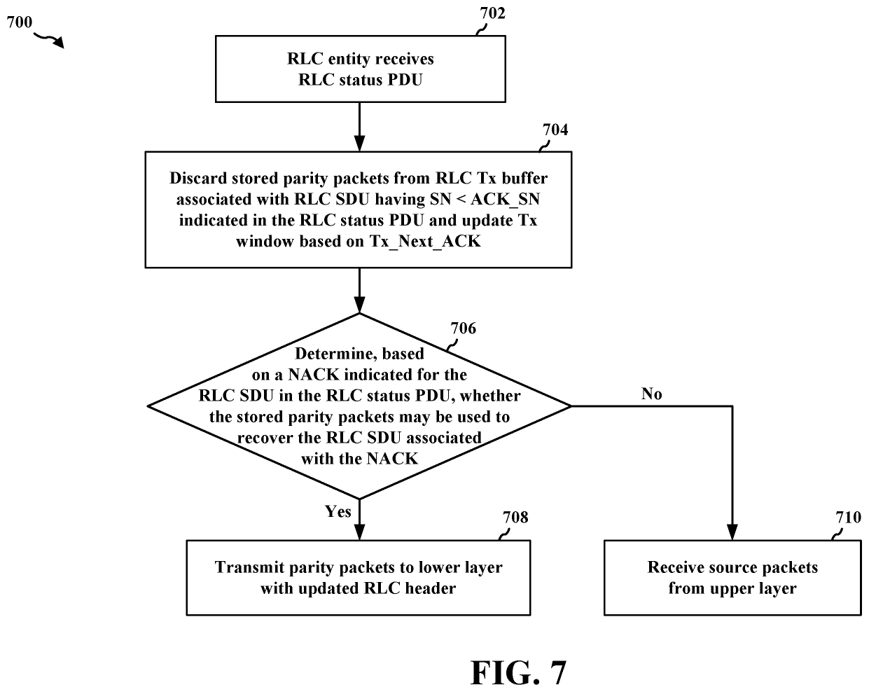

FIG. 7 is a flowchart 700 for a retransmission procedure of a packet. The RLC entity may receive, at 702, an RLC status PDU and update a transmission window based on a transmit next ACK (Tx_Next_ACK) pointer included in the RLC status PDU. For example, if the SN of the packet corresponds to a smaller value than the Tx_Next_ACK pointer, the packet may be confirmed as an ACK packet.

After the RLC entity receives, at 702, the RLC status PDU, each RLC parity PDU associated with the RLC SDU having an SN value that is smaller than an ACK_SN of the RLC status PDU may be discarded, at 704, from the RLC transmission buffer, as each RLC parity PDU that precedes the ACK_SN value may correspond to an ACK packet. The transmission window may be shifted forward/updated, at 704, in some cases based on the ACK_SN value. For example, the ACK_SN may update, at 704, the Tx_Next_ACK pointer, where the pointer may correspond to a beginning of the transmission window.

For each RLC SDU associated with a NACK indicated via the RLC status PDU, the RLC entity may determine, at 706, whether a missing RLC SDU or a missing segment of the RLC SDU may be recovered based on the RLC parity PDUs stored in RLC transmission buffer. For example, the RLC entity may compare a number of stored RLC parity PDUs to a number of encoded RLC PDUs reported via the RLC status PDU. If the number of stored RLC parity PDUs is larger than the number of encoded RLC PDUs reported via the RLC status PDU, the missing RLC SDU or the missing segment of the RLC SDU may be recovered based on the RLC parity PDUs stored in the transmission buffer. The missing number of RLC SDU segments may be determined based on the RLC parity PDUs and/or the coding function/algorithm. If the RLC parity PDUs may be used to recover the missing RLC SDU or the missing segments of the RLC SDU, a retransmission may be performed based on transmitting, at 708, the RLC parity PDUs to the lower layer with an updated header. That is, instead of retransmitting the RLC SDU or the segments of the RLC SDU, the retransmission may be based on transmitting, at 708, the parity packets stored in the RLC transmission buffer.

If the RLC parity PDUs stored in the RLC transmission buffer may not be used to recover the RLC SDU or a segment of the RLC SDU associated with the NACK indicated via the RLC status PDU, the RLC entity may receive, at 710, source packets from the upper layer (e.g., PDCP layer). For example, the RLC transmission buffer may not include enough RLC parity PDUs to recover the RLC SDU or the segment of the RLC SDU. Thus, the RLC entity may request/trigger/pull additional source packets from the upper layer/PDCP layer to perform the retransmission to the lower layer/MAC layer.

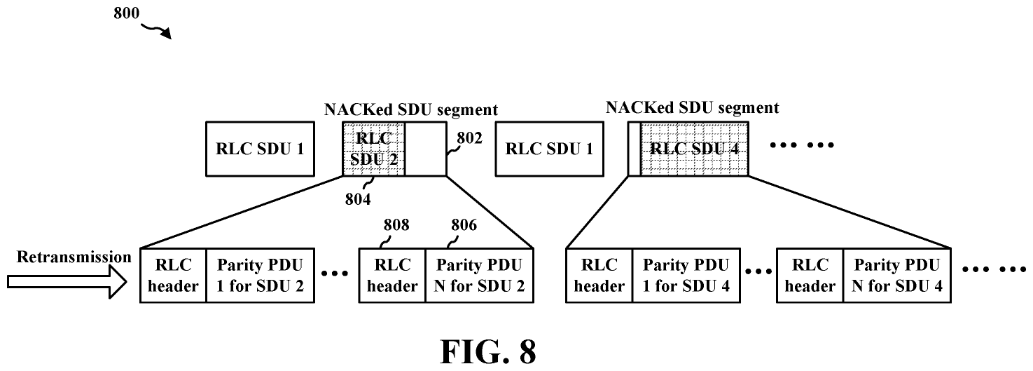

FIG. 8 is a diagram 800 for a retransmission procedure of a packet. If the stored RLC parity PDUs 806 may be used to recover a missing/NACKed segment 804 of an RLC SDU 802, the RLC parity PDUs 806 may be transmitted to the lower layer (e.g., MAC layer) with both an original SN of the RLC SDU 802 and an additional sub_SN field in the RLC header 808 associated with each RLC parity PDU 806. A number of RLC parity PDUs 806 may be generated in association with the source RLC PDUs based on the coding function. The RLC parity PDUs 806 may correspond to the RLC SDU 802, as the coding function for the RLC parity PDUs 806 may be associated with a redundant bit. The RLC parity PDUs 806 may be numbered (e.g., sequentially) so that a receiver device may order the received RLC parity PDUs 806 to assemble the RLC SDU 802 based on a sequence of the RLC parity PDUs 806 associated with the RLC SDU 802. The sub_SN field in each RLC header 808 may be used for assembling the RLC SDU 802 based on retransmissions of the parity packets.

In some examples, the RLC parity PDUs 806 stored in the RLC buffer may not be used to recover the RLC SDU 802 associated with the NACKed segment 804 of the RLC SDU 802. As such, the transmitter device may request/pull source packets from the PDCP layer. For instance, the transmitter device may request/pull source packets from the PDCP layer if the missing RLC SDU information corresponds to a complete RLC SDU 802 or if a missing segment 804 of the RLC SDU 802 may not be recovered via the stored parity packets in the RLC buffer. For uplink procedures, the RLC layer and the PDCP layer may be co-located at a UE modem, such that the RLC transmitter device may request the original RLC SDU 802 from the PDCP layer for RLC layer retransmission to the MAC layer. In uplink configurations where the RLC layer and the PDCP layer are co-located at the UE modem, no additional signaling procedures may be performed for the RLC layer to receive the RLC SDU 802 from the PDCP layer.

For downlink procedures, a transmission from the base station may be performed via a CU and a DU. For instance, an RLC layer in the DU may request/pull the RLC SDU 802 from a PDCP layer in the CU via an F1 interface between the CU and the DU. In a first example, the request may be based on per RLC status PDU triggering. That is, if the RLC transmitter device receives RLC status PDUs associated with ACK/NACK for transmitted packets, the RLC transmitter device may trigger the request for the source packet from the PDCP layer in the CU. In a second example, the request may be based on per received NACK indications for the RLC SDU 802. In some cases, the RLC status PDUs may not indicate NACK information to the RLC layer, and may instead indicate ACK information for the RLC PDUs transmitted to the MAC layer. Hence, the request to receive the source packets from the PDCP layer may be provided to the PDCP layer based on whether the RLC entity receives NACK information in the RLC status PDUs.

In a third example, the request to receive the source packets from the PDCP layer may be timer-based. For example, after an expiration of a timer, the request from the RLC layer to receive source packets from the PDCP layer may be automatically triggered. A prohibit timer may also be utilized to avoid excessive requests from the RLC layer, so that excessive transmissions from the PDCP layer to the RLC layer may be avoided (e.g., to reduce signaling overhead). After the RLC SDU 802 is received at the RLC layer, the complete RLC PDU may be generated and transmitted to the lower layer/MAC layer on retransmission. In some examples, a segmentation of the RLC SDU 802 may also be retransmitted to the lower layer/MAC layer. The RLC SDU 802 requested and received from the PDCP layer may be stored in an RLC retransmission buffer in case further retransmissions are performed by the RLC entity.

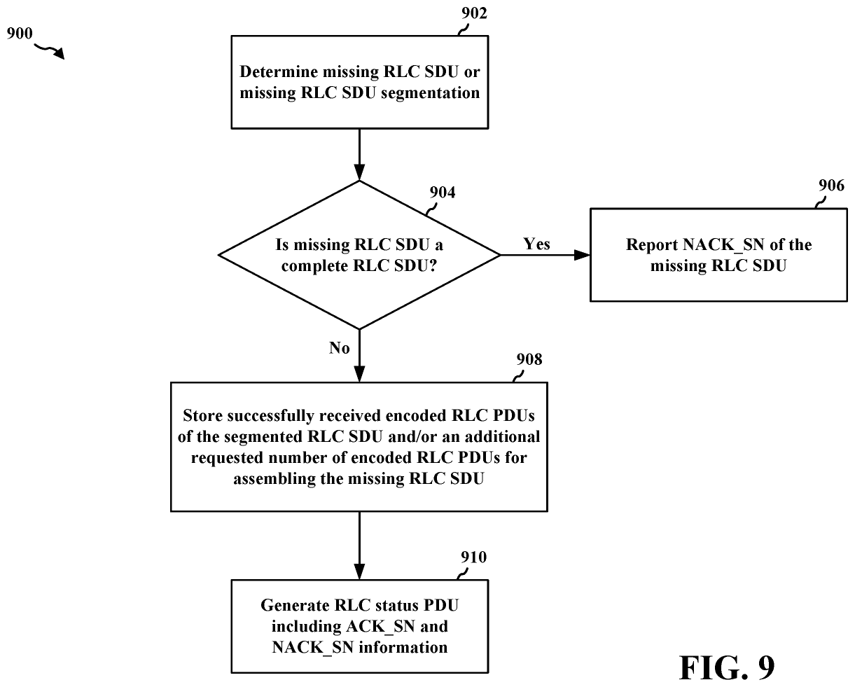

FIG. 9 is a flowchart 900 for a procedure of a receiver device. The receiver device may be configured to generate the RLC status PDUs and report the RLC status PDUs to the RLC transmitter entity. For example, the receiver device may determine, at 902, a missing RLC SDU or a missing RLC SDU segmentation, which may be indicated in the RLC status PDU. That is, the RLC status PDUs may be indicative of missing encoded packet from the RLC transmitter entity. The layer 2 coding function may cause the RLC parity PDUs to be stored in the RLC transmission buffer without the source RLC PDUs. Thus, the RLC status PDUs may indicate missing packet information to the RLC transmitter entity, so that the RLC transmitter entity may transmit the RLC parity PDUs stored in the RLC transmission buffer on retransmission to the receiver device.

The ACK_SN may be included in the RLC status PDUs. If the SN of the associated packet is smaller than the ACK_SN, the RLC transmitter entity may determine that the transmitted packets have been properly received and decoded at the receiver device. If NACK information is included in the RLC status PDU and the missing RLC SDU is determined, at 904, to be a complete RLC SDU, the RLC status PDU may report, at 906, the NACK_SN of the complete/missing RLC SDU.

If the missing RLC SDU is determined, at 904, to be a segment of the RLC SDU, the receiver device may store, at 908, received encoded RLC PDUs of the segmented RLC SDU. The RLC status PDUs may indicate to the RLC transmitter entity a number of successfully received encoded RLC PDUs of the segmented RLC SDU. For example, the RLC SDU may include 10 RLC PDUs and, of the 10 RLC PDUs, 6 RLC PDUs may be properly received and decoded by the receiver device, and 4 RLC PDUs may be missing. Thus, the RLC status PDU may report that 6 packets were received for the missing RLC SDU.

In further aspects, at 908, an additional number of encoded RLC PDUs for assembling the missing RLC SDU (e.g., associated with the NACK) may be indicated/requested via the RLC status PDU. In cases where the receiver device has to receive all 10 packets for recovering the RLC SDU (e.g., based on the coding function), a field in the RLC status PDU indicative of the additional number of encoded RLC PDUs for assembling the RLC SDU may be excluded from the RLC status PDU.

In still further aspects, the RLC status PDUs may indicate a percentage of the missing RLC SDU segments associated with the complete RLC SDU for each missing RLC SDU. For example, the indication may correspond to first, middle, or last segments of the RLC SDU. The receiver device may generate, at 910, the RLC status PDUs, which may include ACK_SN information, NACK_SN information, and/or field(s) that indicate information such as the number of successfully received encoded RLC PDUs per RLC SDU associated with the NACK, the number of additional encoded RLC PDUs for reassembling the RLC SDU associated with the NACK, and/or the percentage of missing RLC SDU segments associated with the complete RLC SDU.

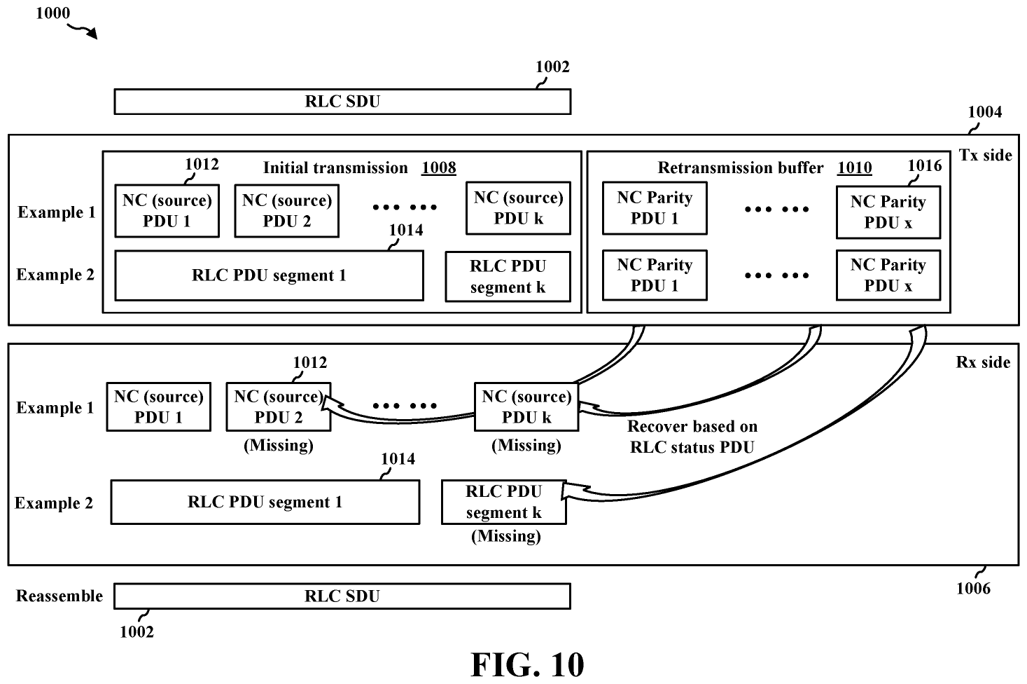

FIG. 10 is a diagram 1000 of a network coding/outer code procedure for an RLC entity. The RLC entity may have a Tx side 1004 and an Rx side 1006. The RLC entity may receive an RLC SDU 1002 from the PDCP layer at the Tx side 1004 of the RLC entity. The Tx side 1004 of the RLC entity may be utilized for an initial transmission 1008 of a packet to the Rx side 1006 of the RLC entity. The Tx side 1004 of the RLC entity may also include a retransmission buffer 1010 for storing information/packets that may be retransmitted to the Rx side 1006 of the RLC entity.

The RLC SDU 1002 received at the Tx side 1004 of the RLC entity may have a corresponding allocation of either network code (NC) source PDUs 1012 or RLC PDU segments 1014. For example, based on a coding function for the RLC SDU 1002, the RLC entity may generate NC source PDU 1 through NC source PDU k. Alternatively, based on the coding function for the RLC SDU 1002, the RLC entity may generate RLC PDU segment 1 through RLC PDU segment k. In both cases, the NC parity PDUs 1016 may be stored in the retransmission buffer that correspond to the NC source PDUs 1012 and the RLC PDU segments 1014. For example, the NC source PDUs 1012 may be associated with NC parity PDU 1 through NC parity PDU x stored in the retransmission buffer 1010. In another example, the RLC PDU segments 1014 may be associated with NC parity PDU 1 through NC parity PDU x stored in the retransmission buffer 1010.

After the initial transmission 1008 of the NC source PDUs 1012 or the RLC PDU segments 1014, the Rx side 1006 of the RLC entity may determine that one or more of the NC source PDUs 1012 or the RLC PDU segments 1014 is missing. The Rx side 1006 of the RLC entity may transmit an RLC status PDU to the Tx side 1004 of the RLC entity for recovering the missing packets based on an indication of the missing packets in the RLC status PDU.

The Tx side 1004 of the RLC entity may transmit the NC parity PDUs 1016 stored in the retransmission buffer 1010 to the Rx side 1006 of the RLC entity based on the indication in the RLC status PDU. The Rx side 1006 of the RLC entity may use the NC parity PDUs 1016 to recover the missing NC source PDUs 1012 or the missing RLC PDU segments 1014 at the Rx side 1006 of the RLC entity. The RLC SDU 1002 may be reassembled based on the Rx side 1006 of the RLC entity using the NC parity PDUs 1016 to recover the missing NC PDUs 1012 or the missing RLC PDU segments 1014.

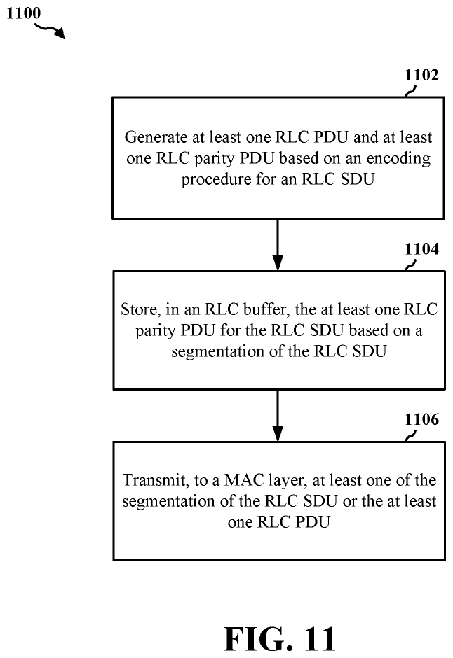

FIG. 11 is a flowchart 1100 of a method of wireless communication. The method may be performed by a Tx device (e.g., the UE 104, base station 180, Tx device 402, the Tx side 1004 of the RLC entity, the apparatus 1502, 1602, etc.), which may include the memory 360 and which may be the entire UE 104, base station 180, Tx device 402, Tx side 1004 or a component of the UE 104, base station 180, Tx device 402, Tx side 1004, such as the TX processor 368, the RX processor 356, and/or the controller/processor 359.

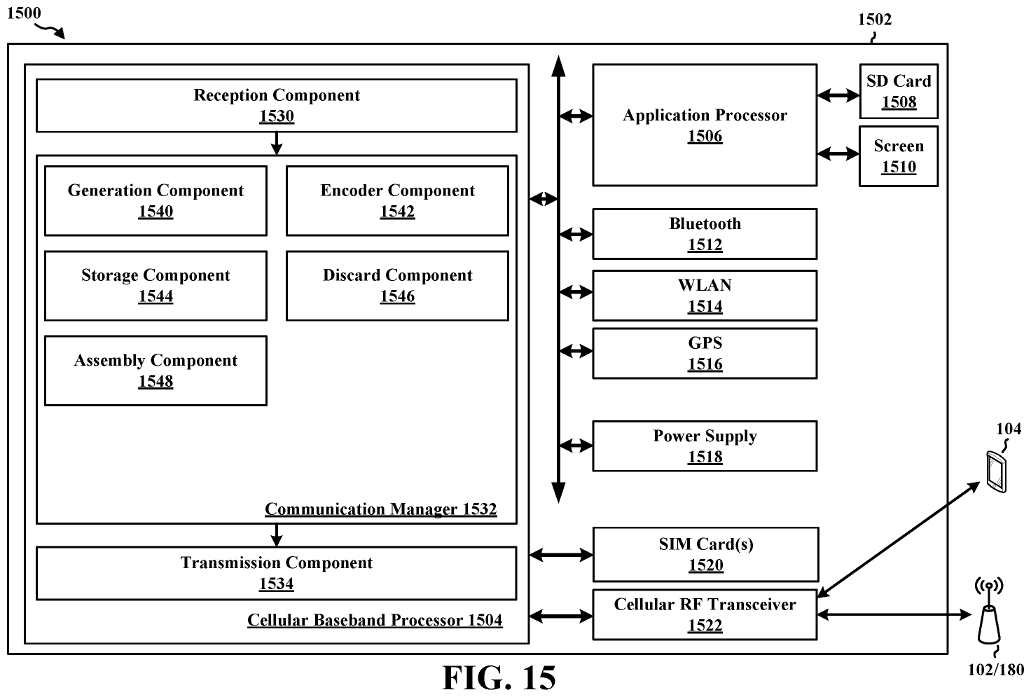

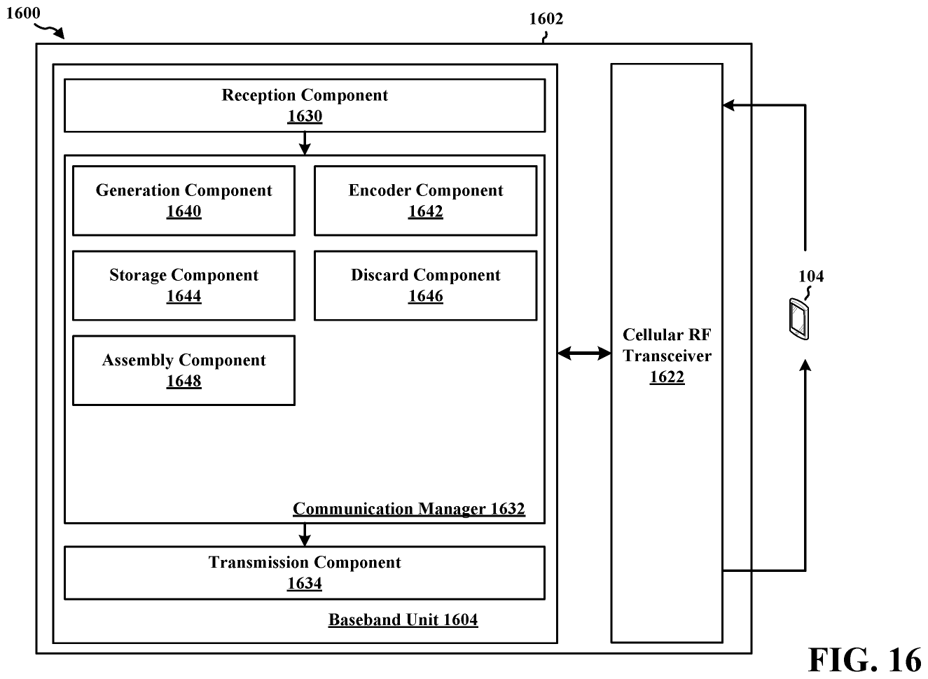

At 1102, the Tx device may generate at least one RLC PDU and at least one RLC parity PDU based on an encoding procedure for an RLC SDU. For example, referring to FIGS. 4, 6, and 10, the Tx device 402 may generate, at 406, RLC PDUs and RLC parity PDUs. In the diagram 600, source RLC PDUs 604 and RLC parity PDUs 606 may be generated based on the RLC SDU 602. In the diagram 650, the RLC PDU 652 and the RLC parity PDUs 656 may be generated based on the RLC SDU 652. In the diagram 1000, the Tx side 1004 of the RLC entity may generate NC source PDUs 1012 and NC parity PDUs 1016. The generation, at 1102, may be performed by the generation component 1540/1640 of the apparatuses 1502/1602 in FIGS. 15-16.

At 1104, the Tx device may store, in an RLC buffer, the at least one RLC parity PDU for the RLC SDU based on a segmentation of the RLC SDU. For example, referring to FIGS. 4, 6, and 10, the Tx device 402 may store, at 410, RLC parity PDUs in an RLC buffer. In the diagrams 600-650, the RLC parity PDUs 606/656 may be stored in the RLC transmission buffer. In the diagram 1000, the NC parity PDUs 1016 may be stored in the retransmission buffer 1010 on the Tx side 1004 of the RLC entity. The storing, at 1104, may be performed by the storage component 1544/1644 of the apparatuses 1502/1602 in FIGS. 15-16.

At 1106, the Tx device may transmit, to a MAC layer, at least one of the segmentation of the RLC SDU or the at least one RLC PDU. For example, referring to FIGS. 4, 6, and 10, the Tx device 402 may transmit, at 412, RLC PDUs to the Rx device 404. In the diagrams 600-650, the encoded source RLC PDUs 604 and the RLC PDU 652 may be transmitted to a lower layer. In the diagram 1000, the NC source PDUs 1012 and the RLC PDU segments 1014 may be transmitted to the lower layer. The transmission, at 1106, may be performed by the transmission component 1534/1634 of the apparatuses 1502/1602 in FIGS. 15-16.

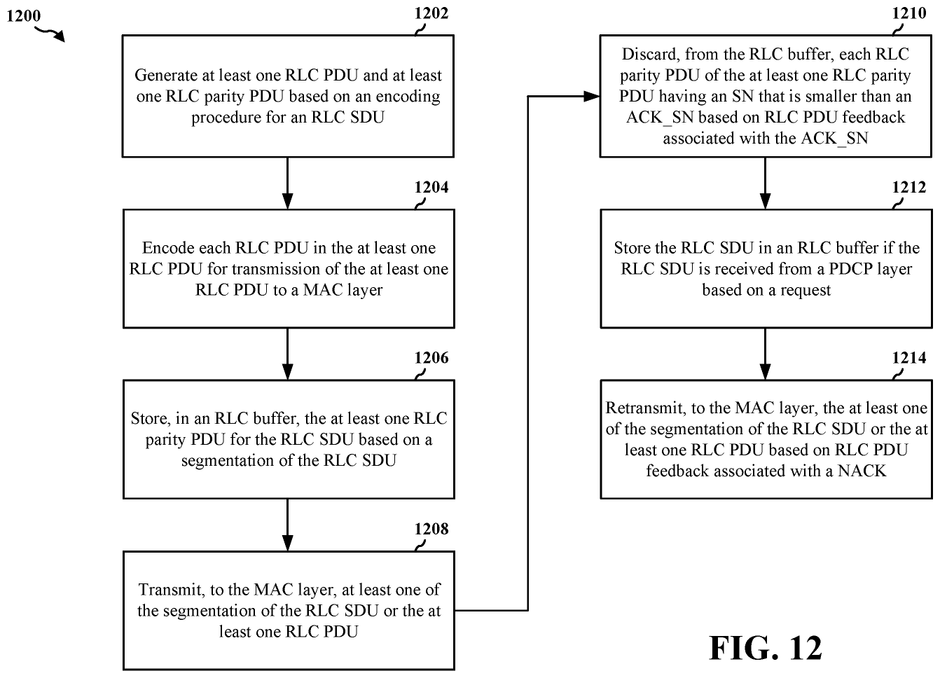

FIG. 12 is a flowchart 1200 of a method of wireless communication. The method may be performed by a Tx device (e.g., the UE 104, base station 180, Tx device 402, the Tx side 1004 of the RLC entity, the apparatus 1502, 1602, etc.), which may include the memory 360 and which may be the entire UE 104, base station 180, Tx device 402, Tx side 1004 or a component of the UE 104, base station 180, Tx device 402, Tx side 1004, such as the TX processor 368, the RX processor 356, and/or the controller/processor 359.

At 1202, the Tx device may generate at least one RLC PDU and at least one RLC parity PDU based on an encoding procedure for an RLC SDU. For example, referring to FIGS. 4, 6, and 10, the Tx device 402 may generate, at 406, RLC PDUs and RLC parity PDUs. In the diagram 600, source RLC PDUs 604 and RLC parity PDUs 606 may be generated based on the RLC SDU 602. In the diagram 650, the RLC PDU 652 and the RLC parity PDUs 656 may be generated based on the RLC SDU 602. In the diagram 1000, the Tx side 1004 of the RLC entity may generate NC source PDUs 1012 and NC parity PDUs 1016. The generation, at 1202, may be performed by the generation component 1540/1640 of the apparatuses 1502/1602 in FIGS. 15-16.

At 1204, the Tx device may encode each RLC PDU in the at least one RLC PDU for transmission of the at least one RLC PDU to a MAC layer. For example, referring to FIGS. 4 and 6, the Tx device 402 may encode, at 408a, each RLC PDU. Each encoded source RLC PDU 604 for the transmission of the at least one RLC PDU may include an RLC header 608. The encoding, at 1204, may be performed by the encoder component 1542/1642 of the apparatuses 1502/1602 in FIGS. 15-16.

At 1206, the Tx device may store, in an RLC buffer, the at least one RLC parity PDU for the RLC SDU based on a segmentation of the RLC SDU. For example, referring to FIGS. 4, 6, and 10, the Tx device 402 may store, at 410, RLC parity PDUs in an RLC buffer. In the diagrams 600-650, the RLC parity PDUs 606/656 may be stored in the RLC transmission buffer. In the diagram 1000, the NC parity PDUs 1016 may be stored in the retransmission buffer 1010 on the Tx side 1004 of the RLC entity. The at least one RLC parity PDU 606, 656, 1016 may not be stored in the RLC buffer (e.g., the retransmission buffer 1010) if at least one of the RLC SDU 602, 1002 is not segmented or the at least one RLC PDU 604, 652, 1010, 1012 corresponds to a single RLC PDU for the RLC SDU 602, 1002. The storage, at 1206, may be performed by the storage component 1544/1644 of the apparatuses 1502/1602 in FIGS. 15-16.

At 1208, the Tx device may transmit, to the MAC layer, at least one of the segmentation of the RLC SDU or the at least one RLC PDU. For example, referring to FIGS. 4, 6, and 10, the Tx device 402 may transmit, at 412, RLC PDUs to the Rx device 404. In the diagrams 600-650, the encoded source RLC PDUs 604 and the RLC PDU 652 may be transmitted to a lower layer. In the diagram 1000, the NC source PDUs 1012 and the RLC PDU segments 1014 may be transmitted to the lower layer. Transmission of the segmentation of the RLC SDU 602, 1002 or a complete RLC SDU 602, 1002 may correspond to a single RLC header 654 and a single RLC PDU 652. The transmission, at 1208, may be performed by the transmission component 1534/1634 of the apparatuses 1502/1602 in FIGS. 15-16.

At 1210, the Tx device may discard, from the RLC buffer, each RLC parity PDU of the at least one RLC parity PDU having an SN that is smaller than an ACK_SN based on RLC PDU feedback associated with the ACK_SN. For example, referring to FIG. 7, the Tx device may discard, at 702, stored parity packets from the RLC Tx buffer associated with RLC SDU having SN<ACK_SN indicated in the RLC status PDU and update a Tx window based on a Tx_Next_ACK. The discarding, at 1210, may be performed by the discard component 1546/1646 of the apparatuses 1502/1602 in FIGS. 15-16.

At 1212, the Tx device may store the RLC SDU in an RLC buffer if the RLC SDU is received from a PDCP layer based on a request. For example, referring to FIGS. 7-8, the Tx device may receive, at 710, source packets from an upper layer that correspond to the RLC SDU. The RLC SDUs 802 may be stored in an RLC retransmission buffer in case retransmissions are to be performed by the RLC entity. The storage, at 1212, may be performed by the storage component 1544/1644 of the apparatuses 1502/1602 in FIGS. 15-16.

At 1214, the Tx device may retransmit, to the MAC layer, the at least one of the segmentation of the RLC SDU or the at least one RLC PDU based on RLC PDU feedback associated with a NACK. For example, referring to FIGS. 4, 7-8, and 10, the Tx device 402 may retransmit, at 420, the RLC parity PDUs to the Rx device 404 based on the RLC PDU feedback received, at 418, from the Rx device 404. In the flowchart 700, the Tx device may transmit, at 708, parity packets to the lower layer with an updated RLC header in association with the NACK indicated in the RLC status PDU. In the diagram 800, the parity PDUs 806 may be transmitted with the RLC header 808 based on the NACKed segment 804 of the RLC SDU 802. In the diagram 1000, the Tx side 1004 of the RLC entity may transmit the NC source PDUs 1012 to the Rx side 1006 of the RLC entity. The retransmission, at 1214, may be performed by the transmission component 1534/1634 of the apparatuses 1502/1602 in FIGS. 15-16.

The retransmission, at 420, may be based on a comparison between a first number of RLC parity PDUs stored, at 410, in the RLC buffer and a second number of encoded RLC PDUs indicated via the RLC PDU feedback, at 418. The first number of RLC parity PDUs and the second number of encoded RLC PDUs may be associated with at least one RLC SDU and at least one NACK. The retransmission, at 420, may trigger a request for the RLC SDU from a PDCP layer. The request for the RLC SDU may be transmitted, via an F1 interface, from a DU to a CU associated with the PDCP layer. The request for the RLC SDU may be based on at least one of the RLC PDU feedback received, at 418, the NACK associated with the at least one of the segmentation of the RLC SDU or the at least one RLC PDU, or a configured timer. The retransmission, at 420, may include a sub-sequence number field having a sub-sequence number for the at least one RLC parity PDU corresponding to the RLC SDU.

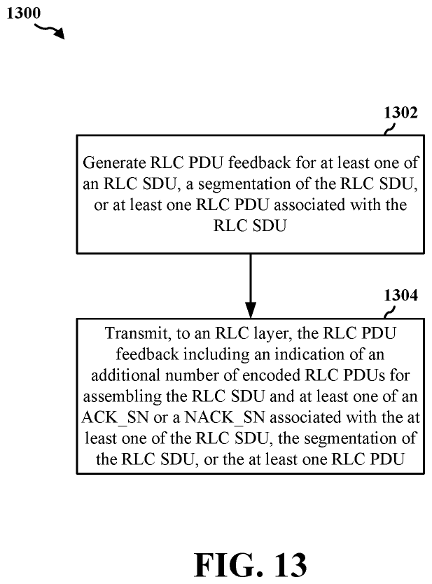

FIG. 13 is a flowchart 1300 of a method of wireless communication. The method may be performed by an Rx device (e.g., the UE 104, base station 102, Rx device 404, the Rx side 1006 of the RLC entity, the apparatus 1502, 1602, etc.), which may include the memory 376 and which may be the entire UE 104, base station 102, Rx device 404, Rx side 1006 or a component of the UE 104, base station 102, Rx device 404, Rx side 1006, such as the TX processor 316, the RX processor 370, and/or the controller/processor 375.

At 1302, the Rx device may generate RLC PDU feedback for at least one of an RLC SDU, a segmentation of the RLC SDU, or at least one RLC PDU associated with the RLC SDU. For example, referring to FIGS. 4 and 9, the Rx device 404 may generate, at 416, RLC PDU feedback (e.g., RLC status PDUs). In the flowchart 900, the Rx device may generate, at 910, RLC status PDUs including ACK_SN and NACK_SN information. The generation, at 1302, may be performed by the generation component 1540/1640 of the apparatuses 1502/1602 in FIGS. 15-16.

At 1304, the Rx device may transmit, to an RLC layer, the RLC PDU feedback including an indication of an additional number of encoded RLC PDUs for assembling the RLC SDU and at least one of an ACK_SN or a NACK_SN associated with the at least one of the RLC SDU, the segmentation of the RLC SDU, or the at least one RLC PDU. For example, referring to FIG. 4, the Rx device 404 may transmit, at 418, RLC PDU feedback indicating ACK_SN information, NACK_SN information, a number of encoded RLC PDUs for assembling the RLC SDU, etc., to the Tx device 402. The transmission, at 1304, may be performed by the transmission component 1534/1634 of the apparatuses 1502/1602 in FIGS. 15-16.

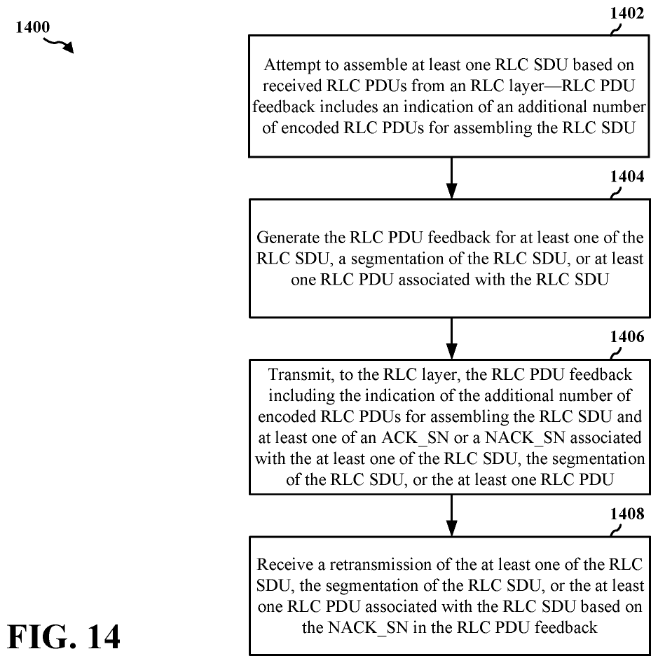

FIG. 14 is a flowchart 1400 of a method of wireless communication. The method may be performed by an Rx device (e.g., the UE 104, base station 102, Rx device 404, the Rx side 1006 of the RLC entity, the apparatus 1502, 1602, etc.), which may include the memory 376 and which may be the entire UE 104, base station 102, Rx device 404, Rx side 1006 or a component of the UE 104, base station 102, Rx device 404, Rx side 1006, such as the TX processor 316, the RX processor 370, and/or the controller/processor 375.

At 1402, the Rx device may attempt to assemble at least one RLC SDU based on received RLC PDUs from an RLC layer-RLC PDU feedback includes an indication of an additional number of encoded RLC PDUs for assembling the RLC SDU. For example, referring to FIGS. 4 and 10, the Rx device 404 may attempt, at 414, to assemble the RLC SDU based on received RLC PDUs, at 412. In the diagram 1000, the Rx side 1006 of the RLC entity may be configured to reassemble the RLC SDU 1002 based on RLC status PDUs transmitted to the Tx side 1004 of the RLC entity for recovering missing packets. The attempt, at 1402, may be performed by the assembly component 1548/1648 of the apparatuses 1502/1602 in FIGS. 15-16.

At 1404, the Rx device may generate the RLC PDU feedback for at least one of the RLC SDU, a segmentation of the RLC SDU, or at least one RLC PDU associated with the RLC SDU. For example, referring to FIGS. 4 and 9, the Rx device 404 may generate, at 416, RLC PDU feedback (e.g., RLC status PDUs). In the flowchart 900, the Rx device may generate, at 910, RLC status PDUs including ACK_SN and NACK_SN information. The RLC PDU feedback generated, at 416, may be indicative of an additional number of RLC PDUs to be received from the RLC layer for assembling the RLC SDU. Further, the RLC PDU feedback generated, at 416, may be indicative of a missing segmentation percentage of a whole RLC SDU received from the RLC layer. The generation, at 1404, may be performed by the generation component 1540/1640 of the apparatuses 1502/1602 in FIGS. 15-16.

At 1406, the Rx device may transmit, to the RLC layer, the RLC PDU feedback including the indication of the additional number of encoded RLC PDUs for assembling the RLC SDU and at least one of an ACK_SN or a NACK_SN associated with the at least one of the RLC SDU, the segmentation of the RLC SDU, or the at least one RLC PDU. For example, referring to FIG. 4, the Rx device 404 may transmit, at 418, RLC PDU feedback indicating ACK_SN information, NACK_SN information, a number of encoded RLC PDUs for assembling the RLC SDU, etc., to the Tx device 402. The transmission, at 418, of the RLC PDU feedback may include a NACK_SN of the RLC SDU if the RLC SDU is not received from the RLC layer. The transmission, at 1406, may be performed by the transmission component 1534/1634 of the apparatuses 1502/1602 in FIGS. 15-16.

At 1408, the Rx device may receive a retransmission of the at least one of the RLC SDU, the segmentation of the RLC SDU, or the at least one RLC PDU associated with the RLC SDU based on the NACK_SN in the RLC PDU feedback. For example, referring to FIGS. 4, 8, and 10, the Rx device 404 may receive, at 420, a retransmission from the Tx device 402 based on the RLC parity PDUs. In the diagram 800, the parity PDUs 806 may be received with the RLC header 808 based on the NACKed segment 804 of the RLC SDU 802. In the diagram 1000, the Rx side 1006 of the RLC entity may receive the NC source PDUs 1012 from the Tx side 1004 of the RLC entity. The retransmission received, at 420, may be based on at least one RLC parity PDU of an RLC buffer and a number of RLC PDUs associated with the NACK_SN. The retransmission received, at 420, may also be triggered based on at least one of the RLC PDU feedback or the NACK_SN in the RLC PDU feedback associated with the at least one of the RLC SDU, the segmentation of the RLC SDU, or the at least one RLC PDU. The retransmission received, at 420, may further include a sub-sequence number field having a sub-sequence number for at least one RLC parity PDU corresponding to the RLC SDU. The reception, at 1408, may be performed by the reception component 1530/1630 of the apparatuses 1502/1602 in FIGS. 15-16.

FIG. 15 is a diagram 1500 illustrating an example of a hardware implementation for an apparatus 1502. The apparatus 1502 may be a UE, a component of a UE, or may implement UE functionality. In some aspects, the apparatus 1502 may include a cellular baseband processor 1504 (also referred to as a modem) coupled to a cellular RF transceiver 1522. In some aspects, the apparatus 1502 may further include one or more subscriber identity modules (SIM) cards 1520, an application processor 1506 coupled to a secure digital (SD) card 1508 and a screen 1510, a Bluetooth module 1512, a wireless local area network (WLAN) module 1514, a Global Positioning System (GPS) module 1516, or a power supply 1518. The cellular baseband processor 1504 communicates through the cellular RF transceiver 1522 with the UE 104 and/or BS 102/180. The cellular baseband processor 1504 may include a computer-readable medium/memory. The computer-readable medium/memory may be non-transitory. The cellular baseband processor 1504 is responsible for general processing, including the execution of software stored on the computer-readable medium/memory. The software, when executed by the cellular baseband processor 1504, causes the cellular baseband processor 1504 to perform the various functions described supra. The computer-readable medium/memory may also be used for storing data that is manipulated by the cellular baseband processor 1504 when executing software. The cellular baseband processor 1504 further includes a reception component 1530, a communication manager 1532, and a transmission component 1534. The communication manager 1532 includes the one or more illustrated components. The components within the communication manager 1532 may be stored in the computer-readable medium/memory and/or configured as hardware within the cellular baseband processor 1504. The cellular baseband processor 1504 may be a component of the UE 350 and may include the memory 360 and/or at least one of the TX processor 368, the RX processor 356, and the controller/processor 359. In one configuration, the apparatus 1502 may be a modem chip and include just the baseband processor 1504, and in another configuration, the apparatus 1502 may be the entire UE (e.g., see 350 of FIG. 3) and include the additional modules of the apparatus 1502.

The communication manager 1532 includes a generation component 1540 that is configured, e.g., as described in connection with 1102, 1202, 1302, and 1404, to generate at least one RLC PDU and at least one RLC parity PDU based on an encoding procedure for an RLC SDU; and to generate the RLC PDU feedback for at least one of the RLC SDU, a segmentation of the RLC SDU, or at least one RLC PDU associated with the RLC SDU. The communication manager 1532 further includes an encoder component 1542 that is configured, e.g., as described in connection with 1204, to encode each RLC PDU in the at least one RLC PDU for transmission of the at least one RLC PDU to a MAC layer. The communication manager 1532 further includes a storage component 1544 that is configured, e.g., as described in connection with 1104, 1206, and 1212, to store, in an RLC buffer, the at least one RLC parity PDU for the RLC SDU based on a segmentation of the RLC SDU; and to store the RLC SDU in an RLC buffer if the RLC SDU is received from a PDCP layer based on a request. The communication manager 1532 further includes a discard component 1546 that is configured, e.g., as described in connection with 1210, to discard, from the RLC buffer, each RLC parity PDU of the at least one RLC parity PDU having an SN that is smaller than an ACK_SN based on RLC PDU feedback associated with the ACK_SN. The communication manager 1532 further includes an assembly component 1548 that is configured, e.g., as described in connection with 1402, to attempt to assemble at least one RLC SDU based on received RLC PDUs from an RLC layer-RLC PDU feedback includes an indication of an additional number of encoded RLC PDUs for assembling the RLC SDU.

The reception component 1530 is configured, e.g., as described in connection with 1408, to receive a retransmission of the at least one of the RLC SDU, the segmentation of the RLC SDU, or the at least one RLC PDU associated with the RLC SDU based on the NACK_SN in the RLC PDU feedback. The transmission component 1534 is configured, e.g., as described in connection with 1106, 1208, 1214, 1304, and 1406, to transmit, to the MAC layer, at least one of the segmentation of the RLC SDU or the at least one RLC PDU; to retransmit, to the MAC layer, the at least one of the segmentation of the RLC SDU or the at least one RLC PDU based on RLC PDU feedback associated with a NACK; and to transmit, to the RLC layer, the RLC PDU feedback including the indication of the additional number of encoded RLC PDUs for assembling the RLC SDU and at least one of an ACK_SN or a NACK_SN associated with the at least one of the RLC SDU, the segmentation of the RLC SDU, or the at least one RLC PDU.

The apparatus may include additional components that perform each of the blocks of the algorithm in the flowcharts of FIGS. 11-14. As such, each block in the flowcharts of FIGS. 11-14 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1502 may include a variety of components configured for various functions. In one configuration, the apparatus 1502, and in particular the cellular baseband processor 1504, includes means for generating at least one RLC PDU and at least one RLC parity PDU based on an encoding procedure for an RLC SDU; means for storing, in an RLC buffer, the at least one RLC parity PDU for the RLC SDU based on a segmentation of the RLC SDU; and means for transmitting, to a MAC layer, at least one of the segmentation of the RLC SDU or the at least one RLC PDU. The apparatus 1502 further includes means for encoding each RLC PDU in the at least one RLC PDU for transmission of the at least one RLC PDU to the MAC layer. The apparatus 1502 further includes means for discarding, from the RLC buffer, each RLC parity PDU of the at least one RLC parity PDU having an SN that is smaller than an ACK_SN based on RLC PDU feedback associated with the ACK_SN. The apparatus 1502 further includes means for retransmitting, to the MAC layer, the at least one of the segmentation of the RLC SDU or the at least one RLC PDU based on RLC PDU feedback associated with a NACK. The means for retransmitting may be further configured to triggers a request for the RLC SDU from a PDCP layer. The apparatus 1502 further includes means for storing the RLC SDU in the RLC buffer if the RLC SDU is received from the PDCP layer based on the request.

In another configuration, the apparatus 1502, and in particular the cellular baseband processor 1504, includes means for generating RLC PDU feedback for at least one of an RLC SDU, a segmentation of the RLC SDU, or at least one RLC PDU associated with the RLC SDU; and means for transmitting, to an RLC layer, the RLC PDU feedback including an indication of an additional number of encoded RLC PDUs for assembling the RLC SDU and at least one of an ACK_SN or a NACK_SN associated with the at least one of the RLC SDU, the segmentation of the RLC SDU, or the at least one RLC PDU. The apparatus 1502 further includes means for attempting to assemble the RLC SDU based on received RLC PDUs from the RLC layer, the RLC PDU feedback including the indication of the additional number of encoded RLC PDUs for assembling the RLC SDU. The apparatus 1502 further includes means for receiving a retransmission of the at least one of the RLC SDU, the segmentation of the RLC SDU, or the at least one RLC PDU associated with the RLC SDU based on the NACK_SN in the RLC PDU feedback.

The means may be one or more of the components of the apparatus 1502 configured to perform the functions recited by the means. As described supra, the apparatus 1502 may include the TX Processor 368, the RX Processor 356, and the controller/processor 359. As such, in one configuration, the means may be the TX Processor 368, the RX Processor 356, and the controller/processor 359 configured to perform the functions recited by the means.

FIG. 16 is a diagram 1600 illustrating an example of a hardware implementation for an apparatus 1602. The apparatus 1602 may be a base station, a component of a base station, or may implement base station functionality. In some aspects, the apparatus 1502 may include a baseband unit 1604. The baseband unit 1604 may communicate through a cellular RF transceiver 1622 with the UE 104. The baseband unit 1604 may include a computer-readable medium/memory. The baseband unit 1604 is responsible for general processing, including the execution of software stored on the computer-readable medium/memory. The software, when executed by the baseband unit 1604, causes the baseband unit 1604 to perform the various functions described supra. The computer-readable medium/memory may also be used for storing data that is manipulated by the baseband unit 1604 when executing software. The baseband unit 1604 further includes a reception component 1630, a communication manager 1632, and a transmission component 1634. The communication manager 1632 includes the one or more illustrated components. The components within the communication manager 1632 may be stored in the computer-readable medium/memory and/or configured as hardware within the baseband unit 1604. The baseband unit 1604 may be a component of the base station 310 and may include the memory 376 and/or at least one of the TX processor 316, the RX processor 370, and the controller/processor 375.

The communication manager 1632 includes a generation component 1640 that is configured, e.g., as described in connection with 1102, 1202, 1302, and 1404, to generate at least one RLC PDU and at least one RLC parity PDU based on an encoding procedure for an RLC SDU; and to generate the RLC PDU feedback for at least one of the RLC SDU, a segmentation of the RLC SDU, or at least one RLC PDU associated with the RLC SDU. The communication manager 1632 further includes an encoder component 1642 that is configured, e.g., as described in connection with 1204, to encode each RLC PDU in the at least one RLC PDU for transmission of the at least one RLC PDU to a MAC layer. The communication manager 1632 further includes a storage component 1644 that is configured, e.g., as described in connection with 1104, 1206, and 1212, to store, in an RLC buffer, the at least one RLC parity PDU for the RLC SDU based on a segmentation of the RLC SDU; and to store the RLC SDU in an RLC buffer if the RLC SDU is received from a PDCP layer based on a request. The communication manager 1632 further includes a discard component 1646 that is configured, e.g., as described in connection with 1210, to discard, from the RLC buffer, each RLC parity PDU of the at least one RLC parity PDU having an SN that is smaller than an ACK_SN based on RLC PDU feedback associated with the ACK_SN. The communication manager 1632 further includes an assembly component 1648 that is configured, e.g., as described in connection with 1402, to attempt to assemble at least one RLC SDU based on received RLC PDUs from an RLC layer-RLC PDU feedback includes an indication of an additional number of encoded RLC PDUs for assembling the RLC SDU.

The reception component 1630 is configured, e.g., as described in connection with 1408, to receive a retransmission of the at least one of the RLC SDU, the segmentation of the RLC SDU, or the at least one RLC PDU associated with the RLC SDU based on the NACK_SN in the RLC PDU feedback. The transmission component 1634 is configured, e.g., as described in connection with 1106, 1208, 1214, 1304, and 1406, to transmit, to the MAC layer, at least one of the segmentation of the RLC SDU or the at least one RLC PDU; to retransmit, to the MAC layer, the at least one of the segmentation of the RLC SDU or the at least one RLC PDU based on RLC PDU feedback associated with a NACK; and to transmit, to the RLC layer, the RLC PDU feedback including the indication of the additional number of encoded RLC PDUs for assembling the RLC SDU and at least one of an ACK_SN or a NACK_SN associated with the at least one of the RLC SDU, the segmentation of the RLC SDU, or the at least one RLC PDU.

The apparatus may include additional components that perform each of the blocks of the algorithm in the flowcharts of FIGS. 11-14. As such, each block in the flowcharts of FIGS. 11-14 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1602 may include a variety of components configured for various functions. In one configuration, the apparatus 1602, and in particular the baseband unit 1604, includes means for generating at least one RLC PDU and at least one RLC parity PDU based on an encoding procedure for an RLC SDU; means for storing, in an RLC buffer, the at least one RLC parity PDU for the RLC SDU based on a segmentation of the RLC SDU; and means for transmitting, to a MAC layer, at least one of the segmentation of the RLC SDU or the at least one RLC PDU. The apparatus 1602 further includes means for encoding each RLC PDU in the at least one RLC PDU for transmission of the at least one RLC PDU to the MAC layer. The apparatus 1602 further includes means for discarding, from the RLC buffer, each RLC parity PDU of the at least one RLC parity PDU having an SN that is smaller than an ACK_SN based on RLC PDU feedback associated with the ACK_SN. The apparatus 1602 further includes means for retransmitting, to the MAC layer, the at least one of the segmentation of the RLC SDU or the at least one RLC PDU based on RLC PDU feedback associated with a NACK. The means for retransmitting may be further configured to triggers a request for the RLC SDU from a PDCP layer. The apparatus 1602 further includes means for storing the RLC SDU in the RLC buffer if the RLC SDU is received from the PDCP layer based on the request.

In one configuration, the apparatus 1602, and in particular the baseband unit 1604, includes means for generating RLC PDU feedback for at least one of an RLC SDU, a segmentation of the RLC SDU, or at least one RLC PDU associated with the RLC SDU; and means for transmitting, to an RLC layer, the RLC PDU feedback including an indication of an additional number of encoded RLC PDUs for assembling the RLC SDU and at least one of an ACK_SN or a NACK_SN associated with the at least one of the RLC SDU, the segmentation of the RLC SDU, or the at least one RLC PDU. The apparatus 1602 further includes means for attempting to assemble the RLC SDU based on received RLC PDUs from the RLC layer, the RLC PDU feedback including the indication of the additional number of encoded RLC PDUs for assembling the RLC SDU. The apparatus 1602 further includes means for receiving a retransmission of the at least one of the RLC SDU, the segmentation of the RLC SDU, or the at least one RLC PDU associated with the RLC SDU based on the NACK_SN in the RLC PDU feedback.

The means may be one or more of the components of the apparatus 1602 configured to perform the functions recited by the means. As described supra, the apparatus 1602 may include the TX Processor 316, the RX Processor 370, and the controller/processor 375. As such, in one configuration, the means may be the TX Processor 316, the RX Processor 370, and the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a wireless transmitter including at least one processor coupled to a memory and configured to generate at least one RLC PDU and at least one RLC parity PDU based on an encoding procedure for an RLC SDU; store, in an RLC buffer, the at least one RLC parity PDU for the RLC SDU based on a segmentation of the RLC SDU; and transmit, to a MAC layer, at least one of the segmentation of the RLC SDU or the at least one RLC PDU.

Aspect 2 may be combined with aspect 1 and includes that the at least one processor is further configured to encode each RLC PDU in the at least one RLC PDU for transmission of the at least one RLC PDU to the MAC layer.

Aspect 3 may be combined with any of aspects 1-2 and includes that each encoded RLC PDU for the transmission of the at least one RLC PDU includes an RLC header.

Aspect 4 may be combined with aspect 1 and includes that the at least one RLC parity PDU is not stored in the RLC buffer if at least one of the RLC SDU is not segmented or the at least one RLC PDU corresponds to a single RLC PDU for the RLC SDU.

Aspect 5 may be combined with any of aspects 1 or 4 and includes that transmission of the segmentation of the RLC SDU or a complete RLC SDU corresponds to a single RLC header and a single RLC PDU.

Aspect 6 may be combined with any of aspects 1-5 and includes that the at least one processor is further configured to discard, from the RLC buffer, each RLC parity PDU of the at least one RLC parity PDU having an SN that is smaller than an ACK_SN based on RLC PDU feedback associated with the ACK_SN.

Aspect 7 may be combined with any of aspects 1-6 and includes that the at least one processor is further configured to retransmit, to the MAC layer, the at least one of the segmentation of the RLC SDU or the at least one RLC PDU based on RLC PDU feedback associated with a NACK.

Aspect 8 may be combined with any of aspects 1-7 and includes that retransmission is based on a comparison between a first number of RLC parity PDUs stored in the RLC buffer and a second number of encoded RLC PDUs indicated via the RLC PDU feedback, the first number of RLC parity PDUs and the second number of encoded RLC PDUs associated with the RLC SDU and the NACK.

Aspect 9 may be combined with any of aspects 1-8 and includes that retransmission triggers a request for the RLC SDU from a PDCP layer.

Aspect 10 may be combined with any of aspects 1-9 and includes that the request for the RLC SDU is transmitted, via an F1 interface, from a DU to a CU associated with the PDCP layer.

Aspect 11 may be combined with any of aspects 1-10 and includes that the request for the RLC SDU is based on at least one of the RLC PDU feedback, the NACK associated with the at least one of the segmentation of the RLC SDU or the at least one RLC PDU, or a configured timer.

Aspect 12 may be combined with any of aspects 1-11 and includes that the at least one processor is further configured to store the RLC SDU in the RLC buffer if the RLC SDU is received from the PDCP layer based on the request.

Aspect 13 may be combined with any of aspects 1-12 and includes that retransmission includes a sub-sequence number field having a sub-sequence number for the at least one RLC parity PDU corresponding to the RLC SDU.

Aspect 14 may be combined with any of aspects 1-13 and further includes at least one of an antenna or a transceiver coupled to the at least one processor.

Aspect 15 is an apparatus for wireless communication at a wireless receiver including at least one processor coupled to a memory and configured to generate RLC PDU feedback for at least one of an RLC SDU, a segmentation of the RLC SDU, or at least one RLC PDU associated with the RLC SDU; and transmit, to an RLC layer, the RLC PDU feedback including an indication of an additional number of encoded RLC PDUs for assembling the RLC SDU and at least one of an ACK_SN or a NACK_SN associated with the at least one of the RLC SDU, the segmentation of the RLC SDU, or the at least one RLC PDU.

Aspect 16 may be combined with aspect 15 and includes that the at least one processor is further configured to attempt to assemble the RLC SDU based on received RLC PDUs from the RLC layer, the RLC PDU feedback including the indication of the additional number of encoded RLC PDUs for assembling the RLC SDU.

Aspect 17 may be combined with any of aspects 15-16 and includes that the RLC PDU feedback is indicative of an additional number of RLC PDUs to be received from the RLC layer for assembling the RLC SDU.

Aspect 18 may be combined with aspect 15 and includes that the RLC PDU feedback is indicative of a missing segmentation percentage of a whole RLC SDU received from the RLC layer.

Aspect 19 may be combined with any of aspects 15-18 and includes that transmission of the RLC PDU feedback includes a NACK_SN of the RLC SDU if the RLC SDU is not received from the RLC layer.

Aspect 20 may be combined with any of aspects 15-19 and includes that the at least one processor is further configured to receive a retransmission of the at least one of the RLC SDU, the segmentation of the RLC SDU, or the at least one RLC PDU associated with the RLC SDU based on the NACK_SN in the RLC PDU feedback.

Aspect 21 may be combined with any of aspects 15-20 and includes that the retransmission is based on at least one RLC parity PDU of an RLC buffer and a number of RLC PDUs associated with the NACK_SN.

Aspect 22 may be combined with any of aspects 15-21 and includes that the retransmission is triggered based on at least one of the RLC PDU feedback or the NACK_SN in the RLC PDU feedback associated with the at least one of the RLC SDU, the segmentation of the RLC SDU, or the at least one RLC PDU.

Aspect 23 may be combined with any of aspects 15-22 and includes that the retransmission includes a sub-sequence number field having a sub-sequence number for at least one RLC parity PDU corresponding to the RLC SDU.

Aspect 24 may be combined with any of aspects 15-23 and further includes at least one of an antenna or a transceiver coupled to the at least one processor.

Aspect 25 is a method of wireless communication for implementing any of aspects 1-24.

Aspect 26 is an apparatus for wireless communication including means for implementing any of aspects 1-24.

Aspect 27 is a computer-readable medium storing computer executable code, the code when executed by at least one processor causes the at least one processor to implement any of aspects 1-24.

What is claimed is:

1. An apparatus for wireless communication at a wireless transmitter, comprising:
a memory; and
at least one processor coupled to the memory and configured to:
generate at least one radio link control (RLC) protocol data unit (PDU) and at least one RLC parity PDU based on an encoding procedure for an RLC service data unit (SDU);
store, in an RLC buffer, the at least one RLC parity PDU for the RLC SDU based on a segmentation of the RLC SDU; and
transmit, to a medium access control (MAC) layer, at least one of the segmentation of the RLC SDU or the at least one RLC PDU.

2. The apparatus of claim 1, wherein the at least one processor is further configured to encode each RLC PDU in the at least one RLC PDU for transmission of the at least one RLC PDU to the MAC layer.

3. The apparatus of claim 2, wherein each encoded RLC PDU for the transmission of the at least one RLC PDU includes an RLC header.

4. The apparatus of claim 1, wherein the at least one RLC parity PDU is not stored in the RLC buffer if at least one of the RLC SDU is not segmented or the at least one RLC PDU corresponds to a single RLC PDU for the RLC SDU.

5. The apparatus of claim 1, wherein transmission of the segmentation of the RLC SDU or a complete RLC SDU corresponds to a single RLC header and a single RLC PDU.

6. The apparatus of claim 1, wherein the at least one processor is further configured to discard, from the RLC buffer, each RLC parity PDU of the at least one RLC parity PDU having a sequence number (SN) that is smaller than an acknowledgment SN (ACK_SN) based on RLC PDU feedback associated with the ACK_SN.

7. The apparatus of claim 1, wherein the at least one processor is further configured to retransmit, to the MAC layer, the at least one of the segmentation of the RLC SDU or the at least one RLC PDU based on RLC PDU feedback associated with a negative acknowledgment (NACK).

8. The apparatus of claim 7, wherein retransmission is based on a comparison between a first number of RLC parity PDUs stored in the RLC buffer and a second number of encoded RLC PDUs indicated via the RLC PDU feedback, the first number of RLC parity PDUs and the second number of encoded RLC PDUs associated with the RLC SDU and the NACK.

9. The apparatus of claim 7, wherein retransmission triggers a request for the RLC SDU from a packet data convergence protocol (PDCP) layer.

10. The apparatus of claim 9, wherein the request for the RLC SDU is transmitted, via an F1 interface, from a distributed unit (DU) to a centralized unit (CU) associated with the PDCP layer.

11. The apparatus of claim 9, wherein the request for the RLC SDU is based on at least one of the RLC PDU feedback, the NACK associated with the at least one of the segmentation of the RLC SDU or the at least one RLC PDU, or a configured timer.

12. The apparatus of claim 9, wherein the at least one processor is further configured to store the RLC SDU in the RLC buffer if the RLC SDU is received from the PDCP layer based on the request.

13. The apparatus of claim 7, wherein retransmission includes a sub-sequence number field having a sub-sequence number for the at least one RLC parity PDU corresponding to the RLC SDU.

14. The apparatus of claim 1, further comprising at least one of an antenna or a transceiver coupled to the at least one processor.

15. An apparatus for wireless communication at a wireless receiver, comprising:
a memory; and
at least one processor coupled to the memory and configured to:
generate radio link control (RLC) protocol data unit (PDU) feedback for at least one of an RLC service data unit (SDU), a segmentation of the RLC SDU, or at least one RLC PDU associated with the RLC SDU; and
transmit, to an RLC layer, the RLC PDU feedback including an indication of an additional number of encoded RLC PDUs for assembling the RLC SDU and at least one of an acknowledgment (ACK) sequence number (SN) (ACK_SN) or a negative acknowledgment (NACK) SN (NACK_SN) associated with the at least one of the RLC SDU, the segmentation of the RLC SDU, or the at least one RLC PDU.

16. The apparatus of claim 15, wherein the at least one processor is further configured to attempt to assemble the RLC SDU based on received RLC PDUs from the RLC layer, the RLC PDU feedback including the indication of the additional number of encoded RLC PDUs for assembling the RLC SDU.

17. The apparatus of claim 15, wherein the RLC PDU feedback is indicative of an additional number of RLC PDUs to be received from the RLC layer for assembling the RLC SDU.

18. The apparatus of claim 15, wherein the RLC PDU feedback is indicative of a missing segmentation percentage of a whole RLC SDU received from the RLC layer.

19. The apparatus of claim 15, wherein transmission of the RLC PDU feedback includes a NACK sequence number (NACK_SN) of the RLC SDU if the RLC SDU is not received from the RLC layer.

20. The apparatus of claim 15, wherein the at least one processor is further configured to receive a retransmission of the at least one of the RLC SDU, the segmentation of the RLC SDU, or the at least one RLC PDU associated with the RLC SDU based on the NACK_SN in the RLC PDU feedback.

21. The apparatus of claim 20, wherein the retransmission is based on at least one RLC parity PDU of an RLC buffer and a number of RLC PDUs associated with the NACK_SN.

22. The apparatus of claim 20, wherein the retransmission is triggered based on at least one of the RLC PDU feedback or the NACK_SN in the RLC PDU feedback associated with the at least one of the RLC SDU, the segmentation of the RLC SDU, or the at least one RLC PDU.

23. The apparatus of claim 20, wherein the retransmission includes a sub-sequence number field having a sub-sequence number for at least one RLC parity PDU corresponding to the RLC SDU.

24. The apparatus of claim 15, further comprising at least one of an antenna or a transceiver coupled to the at least one processor.

25. A method of wireless communication at a wireless transmitter, comprising:
generating at least one radio link control (RLC) protocol data unit (PDU) and at least one RLC parity PDU based on an encoding procedure for an RLC service data unit (SDU);
storing, in an RLC buffer, the at least one RLC parity PDU for the RLC SDU based on a segmentation of the RLC SDU; and
transmitting, to a medium access control (MAC) layer, at least one of the segmentation of the RLC SDU or the at least one RLC PDU.

26. The method of claim 25, further comprising encoding each RLC PDU in the at least one RLC PDU for transmission of the at least one RLC PDU to the MAC layer.

27. The method of claim 25, wherein the at least one RLC parity PDU is not stored in the RLC buffer if at least one of the RLC SDU is not segmented or the at least one RLC PDU corresponds to a single RLC PDU for the RLC SDU.

28. A method of wireless communication at a wireless receiver, comprising:
generating radio link control (RLC) protocol data unit (PDU) feedback for at least one of an RLC service data unit (SDU), a segmentation of the RLC SDU, or at least one RLC PDU associated with the RLC SDU; and
transmitting, to an RLC layer, the RLC PDU feedback including an indication of an additional number of encoded RLC PDUs for assembling the RLC SDU and at least one of an acknowledgment (ACK) sequence number (SN) (ACK_SN) or a negative acknowledgment (NACK) SN (NACK_SN) associated with the at least one of the RLC SDU, the segmentation of the RLC SDU, or the at least one RLC PDU.

29. The method of claim 28, further comprising attempting to assemble the RLC SDU based on received RLC PDUs from the RLC layer, the RLC PDU feedback including the indication of the additional number of encoded RLC PDUs for assembling the RLC SDU.

30. The method of claim 28, wherein the RLC PDU feedback is indicative of an additional number of RLC PDUs to be received from the RLC layer for assembling the RLC SDU.
